(19) United States
(12) Patent Application Publication
(10) Pub. No.: US 2026/0340242 A1
(43) Pub. Date: Oct. 29, 2026

(54) METHOD AND SYSTEM FOR ONE-STEP AGING SIMULATION OF A CIRCUIT TAKING INTO ACCOUNT FULL DYNAMIC STRESS EFFECT OF TRANSISTORS

(71) Applicant: Wallace W Lin, San Jose, CA (US)

(72) Inventor: Wallace W Lin, San Jose, CA (US)

(21) Appl. No.: 19/193,026

(22) Filed: Apr. 29, 2025

(51) Int. Cl. G06F 30/30

(52) U.S. Cl. CPC G06F 30/30

(57) ABSTRACT

A computer method and system for circuit aging simulation that takes into account the full effect of accumulated aging damage induced transistor characteristics change during chip operation is disclosed. The method with the system lift aging damage curves into a higher dimension and co-optimize the aging attributes of transistors between the higher and lower dimensions until the aging curves settle into a balanced and saturated state. Aging attributes are stored in a library database associated with the chip design for future use where huge time saving in circuit aging simulations is expected.

### CROSS-REFERENCE TO RELATED APPLICATION

This application claims the benefit of U.S. Provisional Application No. 63/739,201, filed on Dec. 27, 2024.

### BACKGROUND

### 1. Technical Field

The present disclosure is directed to a method and system that enables a one-step circuit aging simulation taking into account the full effect of interaction between accumulated aging damage and its induced characteristics change of transistors stressed dynamically during chip operation.

### 2. Description of Related Art

Existing circuit aging simulations in the industry carry fundamental drawbacks in terms of its methodology and application. One most notable drawback is the use of a non-physical trend such as a linear one or an uncalibrated nonlinear one in simulations. A linear-extrapolation based circuit aging simulation overestimates aging effect for transistors and hence circuits. On the other hand, the use of multiple time steps in simulation in an effort to catch and make up the effect of accumulated aging induced change on transistor characteristics and in turn the change of the transistor model parameters at these time steps is a nice idea. However, such idea is ruined by the use of inappropriate aging scaling means, yielding misleading aging simulation result at the end.

Similar to the tactic of using short-term physical stress to circuit components or circuit itself in order to accelerate the extraction of long-term circuit damage or lifetime, circuit aging simulation accelerates the estimation for long-term damage via short-term aging simulation. To dramatically reduce the physical stress time is the motive behind the former. Similar motive for greatly cutting down the simulation time is also behind the latter.

The aging effect or damage to the circuit components undergoing stress during circuit operation will change gradually the characteristics of the components. This, as a result, would contribute to the extent of the new aging damage from a subsequent stress.

The damage continues to accumulate over time and continuously impacts the characteristics of transistors and hence the damage result itself. Since it is extremely difficult to characterize and model, in a dynamic manner, the accumulated aging induced change of transistor characteristics, such has been a fundamental issue faced by circuit aging simulation in the industry. How to accurately take into account such interaction effect and reliably predict the aging damage of transistors and circuits is the main subject of this invention.

### SUMMARY

This disclosure presents a method that reliably estimates the true transistor aging damage due to accumulated transistor damage induced transistor characteristics change which occurs in every moment of transistor operation. The method is based on (i) a derived aging model in its simplest and pristine form in which the aging mechanism is let go naturally without constraint during aging simulation of transistors; (ii) a “Forge & Anneal” technique which leads the aging mechanism to settling into a rest state where accurate extraction of the key attributes of the transistor aging model are achieved; and (iii) a technique approximating the discrete transistor damage versus operating time system to a continuum one such that the full dynamic stress effect of transistors can be reflected. This method and its accompanying system enable a one-step aging simulation at any specified time for transistors and circuits with best possible accuracy.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 illustrates a time-line chart of circuit aging simulation according to one embodiment of the present disclosure;

FIG. 2 shows a flowchart for an overview of the invented transistor aging simulation method according to one embodiment of the present disclosure;

FIG. 3 shows a flowchart of how to generate a correlation table which correlates transistor accumulated aging damage to transistor characteristics change induced aging damage according to one embodiment of the present disclosure;

FIG. 4 shows a scatter plot of the elements in the Correlation Table used in obtaining result in FIG. 13 in HCI (Hot Carrier Injection) stress case according to one embodiment of the present disclosure;

FIG. 5 shows a flowchart of “Forge & Anneal” technique in one-transistor case to extract the settled initial aging rate and final saturated aging damage of a transistor during aging simulation for HCI stress case according to one embodiment of the present disclosure;

FIG. 6 illustrates the “Forge & Anneal” process in terms of time-line chart according to one embodiment of the present disclosure;

FIG. 7 illustrate the “Forge & Anneal” process in terms of segments of the accumulated aging damage versus operating time for HCI stress case according to one embodiment of the present disclosure;

FIG. 8 illustrates a discrete system of transistor aging versus operating time with the interval between the two adjacent time points being Δt.

FIG. 9 shows a flowchart of the method for one-step aging simulation of a circuit taking into account full dynamic stress effect of transistors during operation for HCI stress case according to one embodiment of the present disclosure;

FIG. 10 shows a flowchart of the system for one-step aging simulation of a circuit taking into account full dynamic stress effect of transistors during operation for HCI stress case according to one embodiment of the present disclosure;

FIG. 11 is a flowchart describing the newly invented circuit aging simulation methodology in HCI stress case when a chip design is simulated for the first time according to one embodiment of the present disclosure;

FIG. 12 is a flowchart describing the newly invented circuit aging simulation methodology for HCI stress case when a chip design is simulated after the first time according to one embodiment of the present disclosure;

FIG. 13 shows the evolution of the aging damage curve on one transistor in a circuit during “Forge & Anneal” process in HCI stress case according to one embodiment of the present disclosure;

FIG. 14 is the nonlinear least-squares fitting result in one of the “Forge & Anneal” iteration cycles in HCI stress case, showing excellent fitting;

FIG. 15(a) shows how the initial aging rate (r) evolves during “Forge & Anneal” process in HCI stress case according to one embodiment of the present disclosure;

FIG. 15(b) shows how the final saturated aging damage (k) evolves during “Forge & Anneal” process in HCI stress case according to one embodiment of the present disclosure;

FIG. 16 shows the evolution of the aging damage curve on one of the other nine transistors in a circuit during “Forge & Anneal” process in HCI stress case according to one embodiment of the present disclosure;

FIG. 17(a) shows the initial aging rate (r) versus Δt (operating time interval) extracted from one transistor in HCI stress case according to one embodiment of the present disclosure;

FIG. 17(b) shows the saturated aging damage (k) versus Δt (operating time interval) extracted from one transistor in HCI stress case according to one embodiment of the present disclosure;

### DESCRIPTION OF THE EXEMPLARY EMBODIMENTS

The aforementioned and other technical contents, features, and efficacies will be shown in the following detailed descriptions of embodiments corresponding with the reference figures.

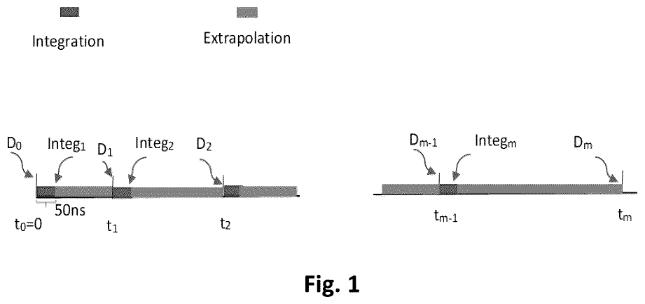

FIG. 1 illustrates a time-line chart of circuit aging simulation. The horizontal darker-color bar denotes the duration of the short-term aging simulation while the lighter-color bar the duration of the longer- or long-term aging simulation. Each time tick represents the beginning of the short-term aging simulation. There are m+1 time ticks from t₀ to tₘ, representing m multiple-step simulations. The reason of requiring short-term simulation is to reduce the total simulation time in each of the multiple-step simulations. The reason of requiring multiple-step simulations is to account for the accumulated aging damage induced transistor aging effect, which affects again subsequent simulation for accumulated aging damage, such that the overall simulation becomes more accurate.

The short- and longer-term simulation form one step of the m-step overall simulations. The dramatic cut of the simulation time in each of all m steps is achieved by scaling the short-term aging effect to long term. This can be performed by either a linear scaling or by an uncalibrated nonlinear trend scaling. Both are non-physical and their scaling results inaccurate.

The aging effect or damage to the circuit components undergoing stress during circuit operation will change gradually the characteristics of the components. This, as a result, would contribute to a further new aging damage from a subsequent stress. This interaction phenomenon can be explained at time tick tₘ₋₁ in FIG. 1. The m^{th} simulation step produces an accumulated aging damage of Dₘ which affects the component characteristics and subsequently the aging damage in the next (m+1^{th}) simulation step, as described in Eqs. (1) and (2) below. The accumulated damage of Dₘ alters value of the characteristics parameters (ΔP_{i_Model|m}) of circuit components. The altered circuit component characteristics in turn affect short-term aging damage in the m+1^{th} simulation step.

ΔP_{i_Model|m}=G(Dₘ) (1)

Integ|ₘ₊₁=f(ΔP_{i_Model|m})=f(G(Dₘ)) (2)

In reality, such phenomenon occurs at every moment continuously during the stress event, as expressed by Eq. (3).

Integ(t)=f(ΔP_{i_Model}(t))=f(G(D(t))) (3)

The damage continues to accumulate over time and continuously impacts the characteristics of the component stressed and hence the damage result itself. Since it is extremely difficult to characterize and model ΔP_{i_Model}(t) dynamically, this interaction between the accumulated aging damage and the component characteristics change has been a fundamental issue faced by aging simulation for transistors and circuits in the industry. How to accurately take into account such interaction effect and accurately predict the aging damage of circuit components is the main purpose of this invention.

This invention aims at overcoming the above issue. A general aging model for transistors is derived first. The model fits the natural aging behavior of transistors. A method is then devised and works with this general aging model and the characteristics of the transistor to accurately simulate the accumulated damage induced aging effect for transistors and circuits. The model and the method are implemented in a C program. The program verifies the model and method with collected aging data of transistors.

### A. General Aging Model

For physical entities including circuit components, a nature-inspired aging model has to possess basic traits as follows. First, there must exist a force that triggers the aging process. Such force may exist at beginning or during part or whole period of the process. Second, the effect of the aging process is continuously accumulated over the period of the process with accumulated effect at every moment of the aging process. Third, a rate of aging is accompanied at every moment of the aging process. In order to be submissive to the simplest and pristine form of the mechanism of this kind, there should exist a minimum number of factors that define the behavior of the process. These factors are morphed into the boundary conditions in the simplest relations at the beginning and the end of the process.

Hot-carrier-injection (HCI) aging simulation is used to demonstrate this invention. It is important to note that besides HCI aging, the technology disclosed in the invention can also apply to other types of aging process such as NBTI (Negative Bias Temperature Instability), PBTI (Positive Bias Temperature Instability), breakdown of transistor gate oxides, etc. HCI aging process has a damage behavior with an initial rising and an eventual saturation trend which can be described in four simplest relations below:

$${lim}_{t = 0} D = {D}_{0} \qquad ( 4 )$$

$${lim}_{t = 0} \frac{dD}{dt} = r \qquad ( 5 )$$

$${lim}_{t = ∞} D = {D}_{∞} \qquad ( 6 )$$

$${lim}_{t = ∞} \frac{dD}{dt} = 0 \qquad ( 7 )$$

Eq. (4) states the state of aging right at beginning of the aging process where the aging effect or damage is D₀ which is usually zero before an aging force is applied. Eq. (5) states that the rate of aging is r at beginning of the process. r may be assumed to be linear given the linearization approximation in an infinitesimal time interval. Eq. (6) describes that after infinitely long time, the impact of the aging effect eventually approaches to a steady state (i.e., saturated state) with a constant damage value of D_{∞}. Eq. (7) describes the rate of aging process approaching to zero after infinitely long time. Eqs. (6) and (7) depict the “worn-out” phenomenon in nature where the entity experiencing the aging process gradually wears out such that the aging process eventually saturates.

Eqs. (4) to (7) can be solved. This gives rise to a solution—a formula for an aging model in its simplest and pristine form, as expressed in Eq. (8).

$$D ( t ) = {D}_{∞} - ( {D}_{∞} - {D}_{0} ) {e}^{- \frac{r}{{D}_{∞ ,}} t} \qquad ( 8 )$$

On circuit components, Eqs. (4) and (5) describe that at the beginning moment before a circuit component such as a transistor experiences stress, the aging behavior appears to be linear with a rate of r given the linearization approximation in an infinitesimal time interval for a nonlinear damaging behavior. The value of the accumulated aging or damaging effect at t=0 before stress is a constant of Do which is usually zero. As the aging effect accumulates, the transistor degrades as its threshold voltage increases and drive current decreases, leading to lesser and lesser damaging effect to the transistor as stress continues. The aging behavior eventually saturates. The aging rate reduces to 0 and the damage value saturates at a constant value of D_{∞} eventually, as described by Equations (6) and (7). For convenience purpose, D_{∞} is renamed to k here. As a result, Eq. (9) below represents the aging model.

$$D ( t ) = k - ( k - {D}_{0} ) {e}^{- \frac{r}{k} t} \qquad ( 9 )$$

### B. Application of Aging Model

Huddles are encountered to make use of the derived aging model here. Extracting the initial aging rate, r, and the steady-state or saturated aging damage, k, of the aging model from practical aging data appears to be nontrivial and unstraightforward. This is because initially there does not exist data that behave the real trend of the aging induced damage of electronic components such as a transistor because r and k has not been extracted yet. Such data must be built step by step gradually from scratch. One needs to come up with an initial guess of r and k from data grossly estimated initially. For example, one may use short-term data to obtain long-term data of transistor damage versus operating time by linearly extrapolating the short-term data to a time long after t=0. By least-squares fitting (LSF) such data to Eq. (9), one is able to obtain a rough initial estimate for r and k. With this r and k value, one begins to launch the process to be described below with a final goal of obtaining a true settled steady-state value of r and k.

First, one constructs a two-point data at t=t₁ and t=50 ns as shown in FIG. 1. Here, 50 ns is chosen for a very short time duration in tens nanosecond range. Various meaningful values can be selected for this very short duration depending on the performance of a circuit design. The aging damage at t=50 ns, Integ1, is obtained via a linear integral of transistor aging in the 50 ns interval. From the two data points, (0, D₀) and (50 ns, Integ1), one calculates r₁. Using the calculated r₁ and the k value obtained earlier in the nonlinear LSF, the aging effect is then extended to t=t₁ to obtain damage occurred during (t₀, t₁) duration with the following formula derived from Eq. (9):

$${D}_{1} = k - ( k - {D}_{0} ) {e}^{- \frac{{r}_{1}}{k} ( {t}_{1} - {t}_{0} )} \qquad ( 10 )$$

To catch and make up the continuously accumulated aging damage effect, the circuit simulator will update transistor model parameter values at the accumulated damage of D₁ to calculate the linear aging integral over the 50 ns interval, Integ2. Further, an aging rate of r₂ can be calculated based on Integ2. The aging effect is then extended to t=t₂ to obtain damage D₂ there by following the formula below:

$${D}_{2} = k - [ k - {D}_{1} ) ] {e}^{- \frac{{r}_{2}}{k} ( {t}_{2} - {t}_{1} )} \qquad ( 11 )$$

Note that k value obtained from the nonlinear LSF previously is used throughout this process. The above process can be repeated to obtain D₃, D₄, . . . , Dₘ₋₁, Dₘ by following Eq. (12) below:

$${D}_{m} = k - [ k - {D}_{m - 1} ) ] {e}^{- \frac{{r}_{m}}{k} ( {t}_{m} - {t}_{m - 1} )} \qquad ( 12 )$$

tₘ is a time point in longer-term aging simulation. Up to this point, one is able to construct data with m+1 points from time zero to tₘ. These m+1 data points provide an opportunity to extract a supposedly improved aging rate, r, and saturated aging damage, k. The extraction can be carried out with a non-linear least-squares fitting to the m+1 data points using Eq. (9).

The above “Forge” process of building D₁ to Dₘ and the “Anneal” process of nonlinear LSF to the assembled data of D₁ to Dₘ for extracting improved r and k constitute one cycle of the “Forge & Anneal” process. Such process is completed when the r and k converge in the LSF procedure.

A. Overview of Aging Simulation Method for a Transistor Dynamically Stressed during Operation

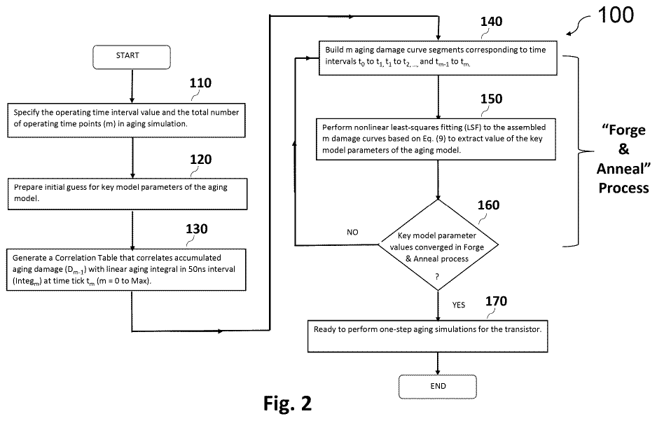

FIG. 2 is the flowchart 100 describing the method of aging simulation for a dynamically-stressed transistor during its operation. The flow starts with step 110 which specifies a standard time interval value, Δt, and the accompanying number of data point, N, for transistor aging simulation.

The next is step 120 which generates a gross estimate of the transistor aging damage versus operating time, Dₙ versus tₙ, with a linear aging integral, Integₙ, in a very short time duration of (tₙ₋₁, tₙ₋₁+50 ns), n=1, 2, 3, . . . , m along with a linear extrapolation of Integₙ at t=tₙ₋₁+50 ns to Dₙ at t=tₙ. The gross estimate of aging damage versus time, through a LSF procedure, will provide initial guess of the initial aging rate (r) and the saturated aging damage (k) to jump-start the “Forge & Anneal” process.

The above is followed by step 130 which creates a correlation table that reflects accumulated transistor aging damage to this damage induced transistor characteristics change. This is accomplished by using the just-generated estimate of aging damage versus time where Dₙ₋₁ is mapped to Integₙ to constitute (Dₙ₋₁, Integₙ) pairs, n=1, 2, 3, . . . , m. The correlation table here will also be used during the “Forge & Anneal” process.

In the next, the “Forge & Anneal” process is performed. Steps 140, 150 and 160 describe the process. In step 140, segments of transistor aging versus operating time are forged and built. In step 150, the forged segments are assembled and go through a nonlinear LSF procedure to extract the two key aging parameters, the initial aging rate (r) and the saturated aging damage (k) of the transistor. Step 160 checks whether the two key parameters in the current cycle of the “Forge & Anneal” process approach to the same values in the previous cycle. If not, the process is repeated until the convergence is reached.

When r and k converge, this concludes the extraction of the two key aging-behavior parameters of the transistor and the step 170, which is one-step aging simulations at any specified operating time, is ready to ensue for the transistor.

### B. Generation of the Correlation Table

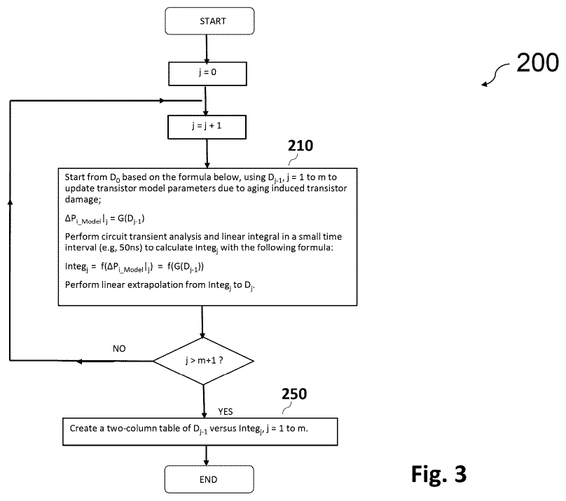

FIG. 3 is the flowchart 200 describing the process of creating a reference table that correlates the accumulated damage of a transistor to this damage induced transistor characteristics change and then the subsequent further damage to the transistor in a 50 ns operating duration. Step 210 starts with damage Do based on the formula of ΔP_{i_Model|j}=G(Dⱼ₋₁), using Dⱼ₋₁, j=1 to m, to update transistor model parameters due to aging induced transistor damage. Circuit transient analysis together with a linear integral in a small time interval of 50 ns is performed to calculate Integⱼ with the formula of Integⱼ=f(ΔP_{i_Model|j})=f(G(Dⱼ₋₁)). A linear extrapolation from Integⱼ to Dⱼ is then performed to obtain transistor aging damage at time tⱼ for next damage-versus-operating-time segment. In step 250, the correlation table is built via mapping Dⱼ₋₁ to Integⱼ to form a table of (Dⱼ₋₁, Integⱼ) pairs, j=1, 2, 3, . . . , m.

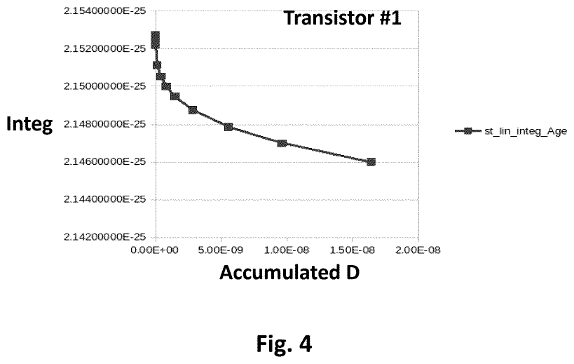

It is important to note that in flowchart 100 Step 120 before the “Forge & Anneal” process, the assembled (Dⱼ, tⱼ) of all segments represents an initial gross estimate for transistor aging damage versus operating time due to linear extrapolation being involved in. However, the correlation table here is by no means an estimate as the (Dⱼ₋₁, Integⱼ) pairs “exactly” reflect the effect from Dⱼ₋₁ based on the updated change of transistor model parameters caused by Dⱼ₋₁. As a result, this correlation table needs only to be generated once at beginning or even ahead of the aging simulation. This avoids repetitive circuit simulations to update transistor model parameters and compute Integ from D due to change of D value in each of the “Forge & Anneal” cycles. The correlation table here provides a means to quickly compute Integ from D with interpolation. The correlation table is one of the key elements contributing to the success of this invention. FIG. 4 shows a scatter plot of the elements, (Dⱼ₋₁, Integⱼ), j=1 to m, in the Correlation Table for a particular transistor case.

### C. Forge and Anneal (One Transistor Case)

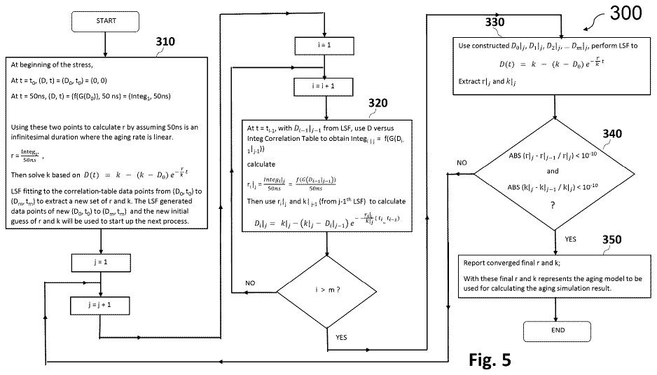

FIG. 5 is a flowchart 300 describing the “Forge & Anneal” process in HCI stress case. As aforementioned, at beginning before the process, a gross estimate for the transistor damage versus operating time is performed first which uses Do (In usual case, Do is assumed to be 0) to obtain ΔP_{i_Model} and then calculate the integration, Integ=f(ΔP_{i_Model}), in a very short duration of 50 ns, followed by a linear extrapolation from the short-term Integ damage to a long-term time scale. This is the initial data set prepared for “Forge & Anneal” process.

Step 310 describes the above “Forge & Anneal” process. Two data points, (0, t₀) and (Integ₁, 50 ns) are used to calculate

$$r = \frac{Integ 1}{50 ns} ,$$

assuming D₀=0 and t₀=0. Then solving k based on

$$D ( t ) = k - ( k - {D}_{0} ) {e}^{- \frac{r}{k} t} .$$

The obtained r and k are used as an initial guess in a nonlinear LSF process for the gross estimate of transistor aging damage versus operating time. The LSF fitting data will be used as the new data set of (Do, t₀) to (Dₘ, tₘ) along with the newly LSF-extracted k as an initial guess to start up the next step.

Step 320 begins the Forge & Anneal process. For each segment of transistor damage versus operating time in duration of (tᵢ, tᵢ₊₁), use D versus Integ Correlation Table, via interpolation, to obtain Integᵢ at tᵢ, i=1, 2, 3, . . . , m. This is followed by calculating

$${r}_{i} = \frac{{Integ}_{i}}{50 ns} .$$

Using rᵢ here and the k obtained in the previous step (310) to calculate a new data set of transistor damage versus operating time based on

$${D}_{i} = k - ( k - {D}_{i - 1} ) {e}^{- - \frac{{r}_{i}}{k} ( {t}_{i} - {t}_{i - 1} )} ,$$

i=1, 2, 3, . . . , m, for each of the damage-versus-time segments. In step 330, Nonlinear LSF is performed on this new data set to extract new r and k, based on

$$D ( t ) = k - ( k - {D}_{0} ) {e}^{- \frac{r}{k} t} .$$

Step 340 describes that the steps 320 & 330 cycle is repeated until both r and k converge. The convergence criterion in the cycle here is the difference of r and K between their current and previous cycle to be less than a pre-determined value which is set to 1e-10% in the case here. The convergence criterion in the LSF procedure to “anneal” and produce new data set of transistor damage versus time is also a pre-determined value and again set to be 1e-10 here. In step 350, the final r and k are reported and ready to be used in circuit aging simulation. The final r and k value here determine the behavior of this transistor during the one-step circuit aging simulation at any operating time point.

The “Forge & Anneal” Technique is the spirit of this invention. The word of “Forge” means the building of the segments of the damage curves from time intervals of t₀ to t₁, t₁ to t₂, . . . , and tₘ₋₁ to tₘ. Note that as detailed in the flowchart 300 of FIG. 5, the initial aging rate, r, in each of the damage curve segments is different as it is calculated based on the accumulated damage of their previous segment respectively. The saturated damage, k, in each of the damage curve segments in the current “Forge & Anneal” cycle is the same. But it is different between different “Forge & Anneal” cycles. It is derived from the LSF result (i.e., during annealing) of the previous “Forge & Anneal” iteration cycle. The accumulated transistor-aging induced damage effect is accounted for inside the calculated initial aging rate in each of the built damage curve segment. Such accumulated aging effect is also accounted for in the updated saturated aging damage in each “Forge & Anneal” cycle. Equivalently, one can say that the accumulated aging damage induced transistor aging effect is taken into account by initial aging rate in “Forge” process and by saturated aging damage in “Anneal” process. The iterated evolution by the “Forge & Anneal” process naturally and gradually leads the initial aging rate as well as the saturated aging damage to their final rest state when the two parameters tend not to change their values eventually. This is how this invention is able to overcome the decades-long hurdle of inaccuracy and confidence problem in transistor and circuit aging simulations.

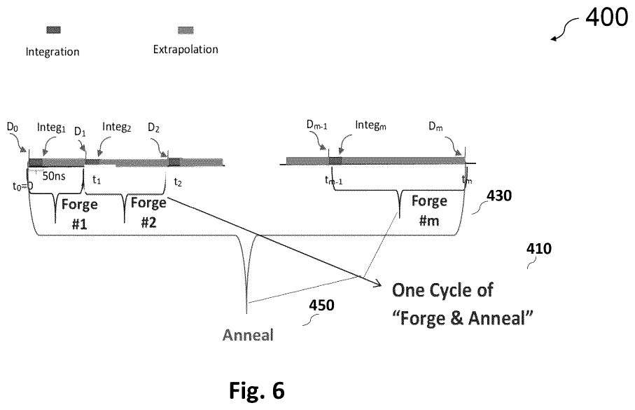

FIG. 6, in the form of illustration 400, shows the “Forge & Anneal” process in terms of time line chart. Step 410 shows that one cycle of the “Forge & Anneal” process comprises two steps, step 430 and step 450. Step 430 shows the Forge process where each of the m damage curve segments is forged (i.e., built) in which the accumulated transistor-aging induced damage effect is incorporated. Step 450 shows the Anneal process where annealing (i.e., in the form of nonlinear least-squares fitting) is performed on the assembled m segments. This annealing step reforms the initial aging rate and the saturated aging damage by letting the two fundamental parameters freely go during LSF procedure without constraint. The two parameters eventually settle into their final rest state.

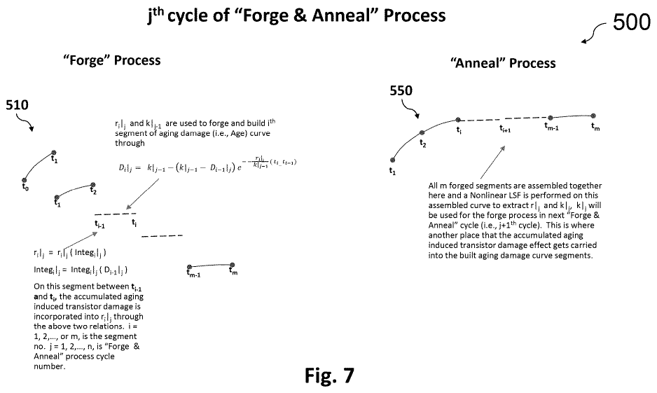

FIG. 7, in the form of illustration 500, shows the “Forge & Anneal” process in terms of segments and a whole of the damage-versus-time curve for HCI stress case. “Forge” process (Step 510) and “Anneal” process (Step 550) are illustrated respectively. “Forge” process is performed in each of the transistor aging damage versus operating time segments. “Anneal” process is performed on the assembled forged-already segments. The accumulated aging induced transistor damage effect via transistor characteristics change is carried into all aging damage segments through the “Forge & Anneal” process.

D. Overview of Aging Simulation Method and system for A Circuit Taking Into Account Full Dynamic Stress Effect of Transistors During Operation

### Methodology

Given a transistor, the calculation of its damage or age as a function of its operation time to reflect the true dynamic interaction between characteristics of the transistor and its accumulated operating-stress induced damage has to consider a continuum system of transistor degradation versus operating time. In real world, the above is just a fantasy as a continuum of time points means an infinitive number of time points. Thus, the question here is “can such puzzle of impossibility be solved?” Obviously, one has to ponder innovatively in quest for an answer.

Indeed, an answer has been engineered in this patent that initially considers a discrete aging damage versus time system and then converts it into a continuum one. The idea is elaborated as follows:

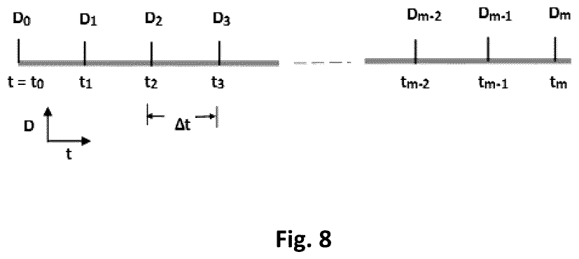

Illustrated in FIG. 8 is a discrete system of transistor aging damage versus operating time with the interval between the two adjacent time points being Δt. A constant Δt would be ideal, however, under such a case, in order to capture the rapidly varying portion of aging behavior, it would require many time points along the damage-versus-time aging curve for aging simulations which is extremely expensive concerning computation resources. Uneven Δt along the damage-versus-time curves appears to be a more realistic approach where an average or equivalent Δt value along the damage-versus-time curve, Δt|ₐᵥ would be an adequate attribute for the damage curve.

The relationship between transistor damage and operating time is described in Eq. (9). For a given Δt, Eq. (9) can be modified to

$${D ( t ) \vert}_{{Δ t \vert}_{av}} = k - ( k - {D}_{0} ) {e}^{- \frac{r}{k} t} \qquad ( 13 )$$

Based on Eq. (13), average Δt can be varied as Δt_{1|av}, Δt_{2|av}, Δt_{3|av}, . . . , or Δt_{m|av} for 1^{st}, 2^{nd}, . . . and m^{th} damage-versus-time curve. These average time intervals are in an ascending order (i.e., Δt_{1|av}<Δt_{2|av}<Δt_{3|av . . .} <Δt_{m|av}). One easy way to produce the m damage-versus-time curves is make the 2^{nd} to m^{th} curves as subsets of the 1^{st} curve. This can be achieved by selecting time points from the 1^{st} curve. For example, selecting the 1^{st}, (i+1)^{th}, (2i+1)^{th}, . . . time points for the i^{th} curve, i=2, 3, 4, . . . . The condition of Int[N/i]+1>3 must be satisfied which sets the maximum number of damage-versus-time curves to be produced, where N is the number of time points in the 1^{st} damage-versus-time curve and int[N/m] is the integer part of N/m division. It will be appreciated by those of ordinary skill in the art that variations or adaptions of the above arrangement for average time intervals of damage-versus-time curves to achieve the same purposes may be substituted for the specific embodiment shown and described without departing from the scope of the present invention. The arrangement above gives rise to different damage versus time data sets or curves:

$${{D}_{1} ( t ) \vert}_{{Δ t 1 \vert}_{av}} = {k}_{1} - ( {k}_{1} - {D}_{0} ) {e}^{- \frac{{r}_{1}}{{k}_{1}} t} \qquad ( 14 )$$

$${{D}_{2} ( t ) \vert}_{{Δ t 2 \vert}_{av}} = {k}_{2} - ( {k}_{2} - {D}_{0} ) {e}^{- \frac{{r}_{2}}{{k}_{2}} t} \qquad ( 15 )$$

$${{D}_{m} ( t ) \vert}_{{Δ t m \vert}_{av}} = {k}_{m} - ( {k}_{m} - {D}_{0} ) {e}^{- \frac{{r}_{m}}{{k}_{m}} t} \qquad ( 16 )$$

As a result, from Eqs. (14-16), one obtains

r=r(Δt|ₐᵥ) (17)

k=k(Δt|ₐᵥ) (18)
where Δt|ₐᵥ is an average operating time interval along the damage-versus-time data curve.

When Δt|ₐᵥ approaches zero, the discrete system of r (Δt|ₐᵥ) and k (Δt|ₐᵥ) would approach to a continuum system. Therefore, the r and k at Δt|ₐᵥ=0 would represent the r and k that reflect the true transistor aging behavior versus operating time due to dynamic interaction between the accumulated transistor aging damage and the transistor characteristics change.

$${{r \vert}_{{Δ t \vert}_{av} = 0} = {lim}_{{Δ t \vert}_{av} = 0} r ( Δ t \vert}_{av} ) \qquad ( 19 )$$

$${{k \vert}_{{Δ t \vert}_{av} = 0} = {lim}_{{Δ t \vert}_{av} = 0} k ( Δ t \vert}_{av} ) \qquad ( 20 )$$

With the r and k obtained from Eqs. (19) and (20), Eq. (9) would produce the transistor aging behavior most close to the reality where transistor characteristics being constantly updated by the influence from the accumulated transistor aging damage during transistor operation. To implement the above methodology into practice, one needs to follow the procedure below.
(1) Design time intervals for the first transistor aging damage versus operating time curve to fully capture the aging behavior. This first damage-versus-time curve, D=D(tᵢ), i=1,2, . . . , N, is produced from a transistor aging simulation with the total number of time points, N. Take an average on values of all time intervals and it is the Δt_{1|av} for this damage-versus-time curve which is equal to

$$\frac{{\sum }_{i = 1}^{i = N} Δ t}{N} = \frac{{\sum }_{i = 1}^{i = N} ( {t}_{i} - {t}_{i - 1} )}{N} ,$$

where Δt=tᵢ−tᵢ₋₁.
(2) Produce the 2^{nd}, 3^{rd}, . . . , and m^{th} damage-versus-time curve with varied average time interval, Δt_{2|av}, Δt_{3|av}, . . . , and Δt_{m|av}, respectively by selecting the 1^{st}, (i+1)^{th}, (2i+1)^{th}, . . . time points for the i^{th} curve, i=2, 3, 4, . . . , with the condition of Int[N/i]+1>3. As such, the average time intervals of these curves will appear in an ascending order (i.e., Δt_{1|av}<Δt_{2|av}<Δt_{3|av} . . . <Δt_{m|av}). This produces respectively the transistor aging damage versus time curve, D=D(tⱼ), j=1, 2, 3, . . . , Int[N/i]+1 where Int[N/n] denotes the integer part of N/n division and Int[N/i]+1 the total number of time points in the i^{th} damage-versus-time curve.
(3) Perform traditional multiple-step circuit aging simulation with linear extrapolation to calculate transistor aging damage along time points in each of the damage-versus-time curves.
(4) Based on Eqs. (14)-(16), applying the “Forge and Anneal” technique described earlier to extract (r₁, k₁), (r₂, k₂), . . . , and (rₙ, kₙ).
(5) Based on Eqs. (19)-(20), extrapolate r(Δt|ₐᵥ) and k(Δt|ₐᵥ) to Δt|ₐᵥ=0. The r and k value at Δt|ₐᵥ=0 together with Eq. (9) constitute the transistor aging behavior in continuum time scale which truly reflects the dynamic interaction of the accumulated transistor aging damage with the transistor characteristics during transistor operation.

### Method

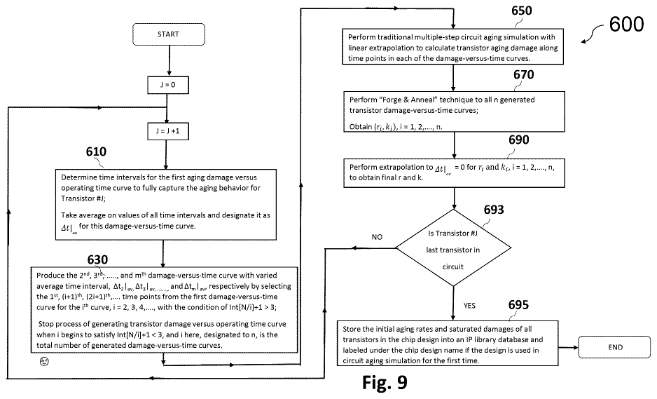

FIG. 9 is the flowchart 600 which is an overview of the method for one-step aging simulation of a circuit taking into account full dynamic stress effect of transistors for HCI stress case. The flow starts with step 610 which determines time intervals for the first aging damage versus operating time curve to fully capture the aging behavior for Transistor #J, J>=1. Average value of all time intervals, Δt|ₐᵥ, is taken for this damage-versus-time curve.

Step 630 generates the 2^{nd}, 3^{rd}, . . . , and m^{th} damage-versus-time curve with varied average time interval, Δt_{2|av}, Δt_{3|av}, . . . , and Δt_{m|av}, respectively. This is achieved by selecting the 1^{st}, (i+1)^{th}, (2i+1)^{th}, . . . time points from the first damage-versus-time curve for the i^{th} curve, i=2, 3, 4, . . . , with the condition of Int[N/i]+1>3. When i begins to satisfy Int[N/i]+1<3, stop process of generating transistor damage versus operating time curve and i here, designated as n, is the total number of generated damage-versus-time curves.

The above is followed by step 650 which performs multiple-step circuit aging simulation with linear extrapolation to calculate transistor aging damage along time points in each of the damage-versus-time curves.

Step 670 performs “Forge & Anneal” process to all n generated transistor damage versus operating time data sets. n initial aging rates and saturated aging damages are extracted accordingly. Step 690 is then performed to extrapolate these initial aging rates and saturated aging damages to Δt|ₐᵥ=0. The “Forge & Anneal” process is performed on all transistors in chip design. Step 693 checks whether the process has been performed on all transistors. If not, then the process will continue on until all transistors are served in the process.

In step 695, the extracted initial aging rates and saturated damages of all transistors in the chip design are stored into an IP library database and labeled under the chip design name if this chip design is used in circuit aging simulation for the first time.

### System

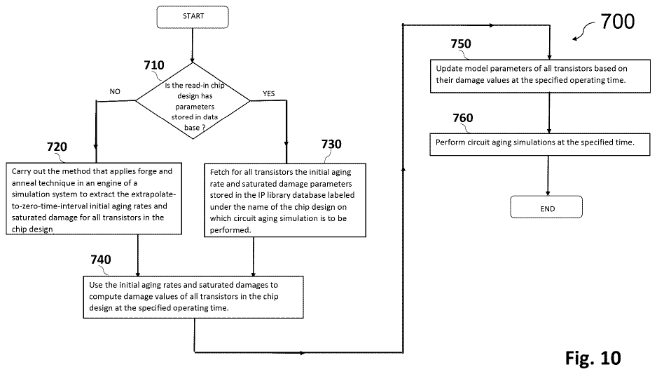

FIG. 10 is the flowchart 700 which is an overview of the system for one-step aging simulation of a circuit taking into account full dynamic stress effect of transistors. The flow starts with step 710 which checks whether the chip design to be simulated already has aging parameters stored in an IP library data base. If no, then step 720 will be carried out. If yes, the flow will move to step 730. In step 720, with the engine of the simulation system, the method that applies forge and anneal technique will be carried out to extract the extrapolate-to-zero-time-interval initial aging rates and saturated damages for all transistors in the chip design. In step 730, the initial aging rate and saturated damage parameters of all transistors stored in the IP library database labeled under the name of this chip design will be fetched.

The above is followed by step 740 where the initial aging rates and saturated damages are used to compute damage values of all transistors in the chip design at the specified operating time. In the next is step 750 which updates model parameters of all transistors based on their damage values calculated in step 740. Once all required steps are completed, circuit aging simulation is then launched, as indicated in step 760.

### E. A New Circuit Aging Simulation Methodology

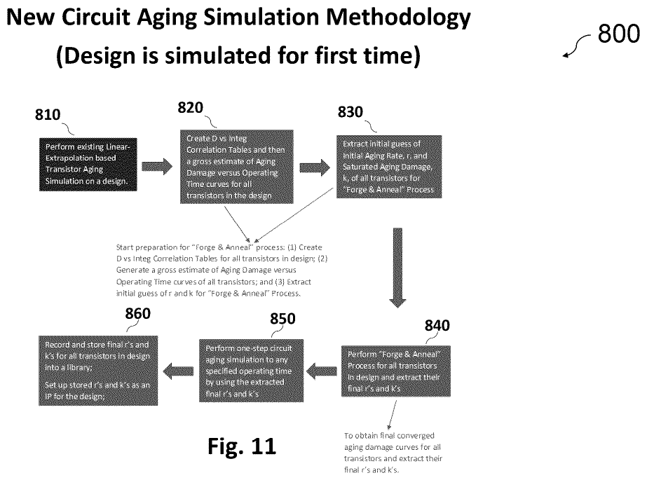

FIG. 11 shows the flowchart 800 which describes a new circuit aging simulation methodology when a chip design is simulated for the first time. HCI is used as a stress example in the new methodology which starts with the existing methodology by performing the linear-extrapolation based transistor aging simulation on a chip design as indicated in step 810. This is followed by the tasks prepared for “Forge & Anneal” process. Among the tasks, in step 820, aging damage versus Integ correlation tables for all transistors in the design are created. Gross estimates of aging damage versus operating time of all transistors are generated next. In step 830, initial guess of Initial Aging Rate, r, and Saturated Aging Damage, k, is extracted for every transistor before the “Forge & Anneal” Process. In step 840, the “Forge & Anneal” Process is performed for all transistors in the design to obtain final converged aging damage versus time curves from which the final r's and k's of all transistors are extracted. In step 850, using the extracted final r's and k's, one-step circuit aging simulation is performed at any specified operating time. In step 860, these extracted final r's and k's are recorded and stored in a library in database and set up as an IP for this chip design.

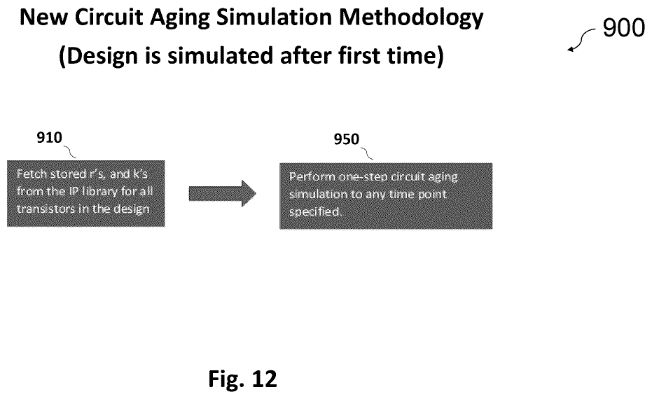

FIG. 12 shows the flowchart 900 which describes a new circuit aging simulation methodology when a chip design is simulated after the first time. Since the values of r's and k's of all transistors in the design are already stored in the library when the design was simulated in the first time, the circuit aging simulation now appears to be quite easy and simple. Only two steps are needed as indicated in flowchart 900. In step 910, r's and k's stored in the IP library are fetched for all transistors in the design. In step 950, one-step circuit aging simulation is performed at any specified operating time by using these fetched r's and k's.

In summary, the new circuit aging simulation methodology inherited in this invention will save tremendous amount of simulation time. This is because under this new methodology, any aging simulations on a chip design other than the first time will just be a one-step computation by plugging in values of r, k and the specified operating time to Eq. (9) to compute damage of all transistors before updating model parameters of the transistors.

### Demonstration Result From Implementation

The invented aging simulation method has been implemented. The following are the result demonstrated from the implementation. A circuit with ten transistors is used here. One transistor is selected first to show how this invented aging simulation method works. A circuit simulator equipped with an appropriate transistor spice model with a traditional aging mechanism is used to simulate the response of the circuit under a bias setup arranged in a circuit netlist file. The nodal current and voltage of the selected transistor are simulated via 50-ns transient analyses. “Age” or damage of HCI (Hot Carrier Injection) stress is computed using the industrial commonly-used formula below:

$${Age \vert}_{NMOS} = {\int }_{0}^{T} \frac{{I}_{ds}}{{WH}_{s}} {( \frac{{I}_{sub}}{{I}_{ds}} )}^{{m}_{s}} dt \qquad ( 21 )$$

$${Age \vert}_{PMOS} = {\int }_{0}^{T} \frac{{I}_{ds}}{{H}_{g}} {( \frac{{I}_{g}}{W} )}^{{m}_{g}} dt \qquad ( 22 )$$

For convenience, the computed “Age” here shall be called “Damage” and denoted with a symbol of D. In the next, a “Damage curve” of this transistor over the time under the stress of circuit operation will be constructed. Since there is no stress before the circuit is operated, D=D₀=0 at t=t₀=0. The 50-ns do transient produces a Damage, Integ₁, at t=50 ns. Using the two data points, one can extend the Damage curve to t=t₁ with linear extrapolation. This gives rise to D=D₁ at tᵢ. Again, one can then compute Integ2 using D₁. By repeating the above process, a Damage curve is constructed via the Damages calculated at t=t₀ to tₘ. This constructed Damage curve serves as an initial damage estimate created before the invented aging simulation method is used. Since there is not yet a realistic Damage curve generated from this simulation method, this initial Damage curve is one that can be best possibly produced at beginning. From here on, the proposed aging simulation method, once applied, will begin to transform this Damage curve gradually into an accurate, reliable and trusted one.

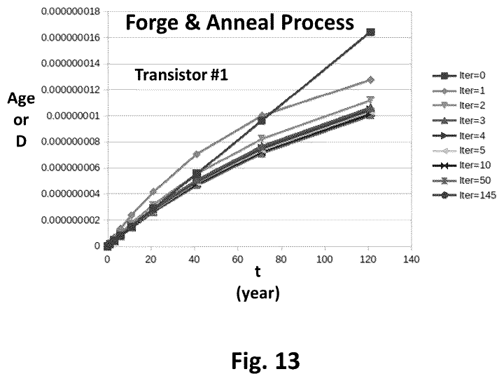

FIG. 13 shows the evolution of the Damage curve during “Forge & Anneal” process on one transistor. The curve transforms from the initial one created before the new circuit aging simulation method starts (process iteration #=0) to the final converged one with the new method. The transformation begins rapidly in the first few “Forge & Anneal” iterations (i.e., cycles). The evolution slows down and leveled eventually when extracted r and k become saturated (process iteration #=148) where both r and k values in “Forge & Anneal” process converges under a tolerance of accuracy criterion of 10⁻¹⁰.

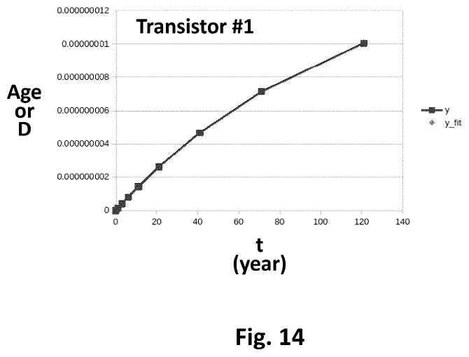

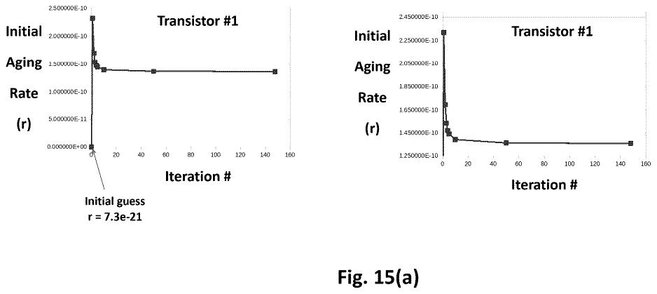

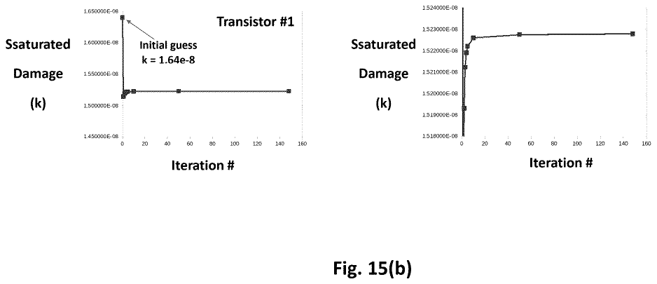

FIG. 14 is a nonlinear least-squares fitting result in one of the “Forge & Anneal” iteration cycles on the transistor, showing excellent fitting. FIGS. 15(a) and 15(b) shows how r and k evolve during “Forge & Anneal” process. The first data point (Iteration #=0) at t=tₙ=0, corresponding to initial guess of r and k at right beginning of the “Forge & Anneal” process, shows that both parameters are quite off from the correct trend. The figure shows that r and k are set back to the right track of the trend very quickly in first few iterations of the “Forge & Anneal” process. Both parameters eventually saturate to their final values.

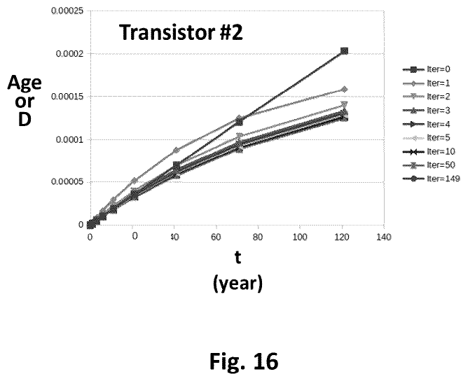

The above implementation is also successfully applied to other transistors in the circuit. FIG. 16 demonstrates the evolution of the Damage curve on one of these other nine transistors during “Forge & Anneal” process. Note that due to higher node currents and voltages in this transistor during circuit operation, it has much higher aging damage comparing with the transistor referred in FIG. 13.

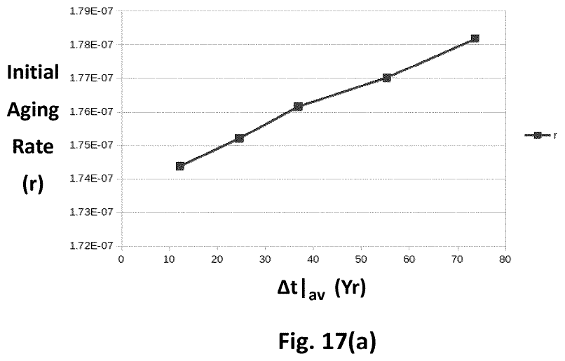

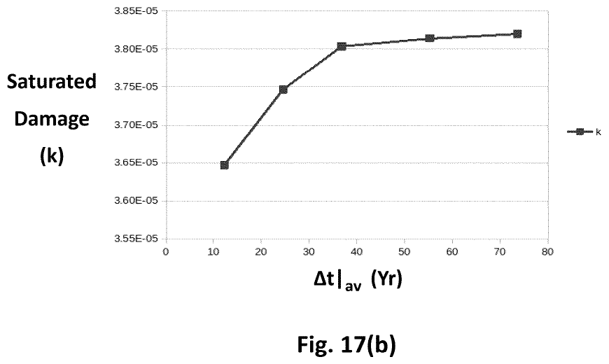

FIGS. 17(a) and 17(b) show the initial aging rate (r) and the saturated damage (k) versus Δt|ₐᵥ extracted from another transistor based on Eqs. (13) to (20). Time intervals were uneven along the operating time points. The first transistor aging damage versus operating time data set has total 18 time points with Δt|ₐᵥ of 12.3 years. This is followed by total data points of 9, 6, 4, and 3 in the 2^{nd}, 3^{rd}, 4^{th}, and₅^{th} damage-versus-time curve, respectively. Their Δt|ₐᵥ's are 24.6, 36.8, 55.3 and 73.7 years, respectively. The initial aging rate shown in FIG. 17(a) appears to be in a linear trend. The saturated damage shown in FIG. 17(b) appears to be nonlinear.

Least-squares fitting both trends and extending the fitting line to Δt|ₐᵥ=0 give rise to the final r and k, 1.735e-7 and 3.5e-5, for the transistor. Using these two parameters, the aging damage value of a dynamically stressed transistor can be accurately obtained at any operating time based on Eq. (9). This is because by Δt|ₐᵥ=0, a discrete system of the transistor aging damage versus operating time is converted into a continuum one, one that continuously takes into account accumulated aging induced transistor characteristics change at every moment of the transistor operation.

The aging mechanisms and models developed earlier for transistors have been widely used in industry, as shown in those commercial circuit simulation tools. However, applying them in circuit aging simulation for a long-term time scale would inevitably invite accuracy issue in the result. The reason is that spending a moderate amount of time to accomplish such simulation in a scale of long-term period would require a short-cut approach to shorten simulation time. Theoretically, updating transistor characteristics very often at every of extremely small time intervals to reflect the accumulated aging effect induced transistor damage and its further influence would render more accurate aging simulation result. Unfortunately, such practice would make simulation time extremely long, expensive and thus unacceptable. This trade-off between accuracy and simulation time in aging simulation has been a tough problem in the industry. This is not easy to be solved unless a breakthrough can be made somehow.

The invented aging simulation method here presents an innovation that breaks through the traditional thinking in tackling this decades-long problem. An aging model developed in this invention for HCI stress case serves as a carrier to successfully demonstrate that the solution to the above problem can be achieved. This aging model, described in Eq. (9) or Eqs. (10)-(12), is different from Eqs. (21)-(22) that describe transistor aging mechanism. Rather, it is a model modeling the result obtained from aging damage calculated based on Eqs. (21)-(22). It, in a way, is similar to those models developed during stress-experiment based characterization, but it is physically based, rather than empirical. It is in its simplest and pristine form, based on Eqs. (4)-(7), with only two parameters, the initial aging rate at the beginning and the final saturated state of aging damage at time infinity. This aging model collaborates with the spirit of this invented aging simulation method, the “Forge & Anneal” technique, so that successful tasks can be achieved.

One may realize by thinking deeper that the philosophy behind this invented new transistor and circuit aging simulation methodology is that if one is to replace the existing multiple-step aging simulation methodology to a one-step aging simulation methodology, then one has to incorporate the interaction between the accumulated aging induced transistor damage and the transistor characteristics change into one-step aging simulation. The “Forge & Anneal” technique introduced in this invention serves to carry out such critical mission. This invention lifts the problem one dimension higher where the accumulated aging induced transistor damage effect and the transistor characteristics change and its further influence are mingled, incorporated and processed. With the assistance of the “Forge & Anneal” technique, a discrete damage-versus-time system is gradually transformed into a continuum one which becomes to possess the attributes of the aging damage behavior of a dynamically stressed transistor (i.e., a transistor stressed at every moment of its operation). Such is the very reason behind the enabling of the one-step circuit aging simulation at any specified operating time which is the ultimate way to dramatically cut down circuit aging simulation time. The “Forge & Anneal” technique is such a higher dimension working with the existing dimensions to show a way that transistor and circuit aging simulation result can be reliable and confidently trusted. In this “Forge & Anneal” technique, the confidence and trust of the result lie in the “convergence” of the final aging damage versus stress time curves.

It is also important to note the role of the initial (i.e., the very first) Damage curve generated with linear extrapolation from the 50 ns-duration linearly-integrated aging damage. There are two purposes to have this initial Damage curve. First, this data in conjunction with their corresponding 50 ns-duration linearly-integrated aging damage are used to produce the Correlation Table which is used to facilitate the calculation of Integᵢ, i=1 to m, in each iteration cycle of the “Forge & Anneal” process. Second, the data are used in a LSF procedure before the “Forge & Anneal” process to extract a rough initial aging rate and steady-state aging damage to serve as an initial guess for the upcoming “Forge & Anneal” process. Fairly to say, this jumpstarts the “Forge & Anneal” process.

The success of the demonstration for this invention indicates that the multiple-step circuit aging simulation methodology used in the industry can be replaced with a one-step one. This is because the converged Damage curve, with the converged final r and k, at the end of “Forge & Anneal” process has already incorporated the accumulated aging induced transistor damage effect into itself. The one-step circuit aging simulation here enables to directly simulate transistor and circuit aging damage at any operating time point.

The “Forge & Anneal” technique disclosed here uses HCI (Hot Carrier Injection) as a stress example. The technique may be implemented in other fields that involve events of stress, wear-out, etc., besides in the field of electronics. These other fields include, but not limited to, thermal, electrothermal, electrical, mechanical, chemical or materials field. In semiconductor area, this technique may be implemented for NBTI, PBTI, TDDB, etc. stress for transistors, in addition to the HCI stress which is used as a demonstration in this invention. With a relation of transistor characteristics to the stress, Eqs. (1)-(3), a stress-damage-versus-time aging model [e.g., Eqs. (4)-(12) for HCI stress], and a physical transistor aging model due to a particular type of stress [e.g., Eqs. (21)-(22) for HCI stress], NBTI, PBTI, and other types of stress can easily be implemented into circuit simulators with the “Forge & Anneal” technique for transistor and circuit aging simulations. Due to the reliability and accuracy concern in lifetime prediction for device components, this technique is expected to play important role in mission-critical industry such as automotive, medical implant, aviation, space, military, etc.

Although specific embodiments have been illustrated and described herein for purposes of description, it will be appreciated by those of ordinary skill in the art that a wide variety of alternate and/or equivalent implementations calculated to achieve the same purposes may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein.

What is claimed is:

1. A computer method of estimating an aging damage of a transistor dynamically stressed during a chip operation, in a one-step procedure at a specified operating time, comprising:
implementing an aging model wherein the transistor follows a behavior dictated by a stress;
determining a plurality of values of average chip operating time intervals that correspond to a plurality of aging-damage-versus-operating-time data curves;
generating a gross estimate of a chip operation induced aging damage on the transistor over a period of operating time for each of the average chip operating time intervals;
generating a correlation table between the chip operation induced damage and the subsequent transistor-characteristics-change induced damage calculated in a pre-determined tens-nanosecond-range duration for each of the aging-damage-versus-operating-time data curves;
enforcing a forge and anneal technique to each of the damage-versus-operating-time data curves; and
performing extrapolation to a zero average chip operating interval on the converged aging parameters from the forge and anneal technique to extract the final aging parameters reflecting full dynamic stress effect on the transistor.

2. The computer method according to claim 1, wherein the one-step procedure enables the method, at any specified operating time, to estimate transistor damage taking into full account the accumulated aging effect on the dynamically stressed transistor without going through traditionally used multiple-step estimate procedure.

3. The computer method according to claim 1, wherein the aging model observed by the transistor further comprising a plurality of aging parameters governing the aging mechanism.

4. The computer method according to claim 1, wherein the stress includes hot carrier injection (HCI), positive bias temperature instability (PBTI), negative bias temperature instability (NBTI), dielectric breakdown, and others related to electrical, thermal, electrothermal, mechanical effect on the transistor.

5. The computer method according to claim 1, wherein the average chip operating time interval is the average of all intervals between every two adjacent time points in the aging-damage-versus-operating-time curve.

6. The computer method according to claim 1, wherein the values associated with the plurality of the average chip operating time intervals determine the number of the operating time points in each of the damage-versus-operating-time data curves.

7. The computer method according to claim 1, wherein the values of the average chip operating time intervals are in ascending order with an increment set at the value of the chip operating time interval of the first damage-versus-operating-time data curve.

8. The computer method according to claim 6, wherein the number of the operating time points has a minimum of three.

9. The computer method according to claim 1, wherein the forge and anneal technique further comprising
performing a nonlinear-least-squares fit to each of the gross estimates of the chip operation induced damage corresponding to the average chip operating time intervals based on the implemented aging model to extract the aging parameters of the transistor as an initial guess for use in a forge and anneal process; and
performing a repeated forge and anneal process to extract the final converged aging parameters of the transistor.

10. The forge and anneal technique according to claim 9, wherein the forge and anneal process further comprising
computing damage of the transistor in the pre-determined tens-nanosecond-range duration using the correlation table at the current operating time point;
computing transistor damage using the implemented aging model for next operating time point;
repeating the above process till the last operating time point to create a curve of transistor aging damage versus operating time; and
performing the nonlinear least-squares fit to the generated curve of aging damage versus operating time to obtain the final settled aging parameters of the transistor.

11. The forge and anneal technique according to claim 9, wherein the repeated forge and anneal process iterates the forge and anneal process until the settled aging parameters of the transistor in current and previous iteration converge to same values within a pre-determined error tolerance.

12. The forge and anneal technique according to claim 1, wherein the final aging parameters of the transistor extracted at zero average chip operating time interval are used to estimate aging damage of the transistor dynamically stressed during the chip operation.

13. A computer system comprising a simulation engine and a library database, capable of estimating an aging damage of a dynamically stressed chip circuit in a one-step procedure at a specified operating time, comprising:
computing aging damage values of all transistors at the specified operating time using the aging parameters extracted from all transistors in the chip circuit;
updating model parameters of all transistors; and
performing circuit aging simulation.

14. The computer system according to claim 13, wherein the aging parameters extracted from all transistors in the chip circuit are stored in the library database and labeled with the chip circuit design name when the chip circuit design is used in circuit aging simulation for the first time.

15. The computer system according to claim 14, wherein the aging parameters stored in the library database are fetched to compute aging damage values of all transistors in the chip circuit design at the specified operating time when the same chip design is simulated in the future.
